(19) United States
(12) Patent Application Publication
(10) Pub. No.: US 2020/0166926 A1
(43) Pub. Date: May 28, 2020

(54) CONTROL METHOD, AIRCRAFT CONTROL SYSTEM, AND ROTORCRAFT

(71) Applicant: SZ DJI TECHNOLOGY CO., LTD., Shenzhen (CN)

(72) Inventors: Huaiyu LIU, Shenzhen (CN); Yifan WU, Shenzhen (CN)

(21) Appl. No.: 16/594,437

(22) Filed: Oct. 7, 2019

Related U.S. Application Data
(63) Continuation of application No. PCT/CN2017/079976, filed on Apr. 10, 2017.

(51) Int. Cl. G05D 1/00; B64D 47/08; B64C 39/02; G05D 1/10

(52) U.S. Cl. CPC G05D 1/0016; B64D 47/08; B64C 39/024; B64C 2201/042; B64C 2201/146; B64C 2201/027; G05D 1/101

(57) ABSTRACT

A control method includes controlling a rotorcraft to fly forward and, in response to receiving signal indicating a motion state of a body part of a user obtained and communicated by a wearable electronic device, performing a control operation according to the motion state. The control operation includes at least one of controlling a rotor motor of the rotorcraft to control a flight direction of the rotorcraft or controlling a rotation direction of a gimbal of the rotorcraft.

### CROSS-REFERENCE TO RELATED APPLICATION

This application is a continuation of International Application No. PCT/CN2017/079976, filed on Apr. 10, 2017, the entire contents of which are incorporated herein by reference.

### TECHNICAL FIELD

The present disclosure relates to consumer electronics and, more particularly, to a control method, an aircraft control system, and a rotorcraft.

### BACKGROUND

Aircrafts are generally controlled by a remote controller. However, the remote controller is generally required to be operated by a user using his two hands. Therefore, the operation is complex and does not liberate the user's hands.

### SUMMARY

In accordance with the disclosure, there is provided a control method including controlling a rotorcraft to fly forward and, in response to receiving signal indicating a motion state of a body part of a user obtained and communicated by a wearable electronic device, performing a control operation according to the motion state. The control operation includes at least one of controlling a rotor motor of the rotorcraft to control a flight direction of the rotorcraft or controlling a rotation direction of a gimbal of the rotorcraft.

Also in accordance with the disclosure, there is provided an aircraft control system including a rotorcraft, a wearable electronic device communicating with the rotorcraft, and a processor. The rotorcraft includes a rotor motor and a gimbal. The wearable electronic device includes a motion detector configured to acquire a motion state of a body part of a user. The processor is configured to control the rotorcraft to fly forward and, in response to receiving signal indicating the motion state sent by the wearable electronic device, perform a control operation according to the motion state. The control operation includes at least one of controlling a rotor motor of the rotorcraft to control a flight direction of the rotorcraft or controlling a rotation direction of a gimbal of the rotorcraft.

### BRIEF DESCRIPTION OF THE DRAWINGS

In order to provide a clearer illustration of technical solutions of disclosed embodiments, the drawings used in the description of the disclosed embodiments are briefly described below. The following drawings are merely some embodiments of the present disclosure. Other drawings may be obtained based on the disclosed drawings by those skilled in the art without creative efforts.

FIG. 1 is a schematic flow chart of a control method consistent with embodiments of the disclosure.

FIG. 2 is a schematic block diagram of an aircraft control system consistent with embodiments of the disclosure.

FIG. 3 is a schematic flow chart of another control method consistent with embodiments of the disclosure.

FIG. 4 is a schematic flow chart of another control method consistent with embodiments of the disclosure.

FIG. 5 is a schematic flow chart of another control method consistent with embodiments of the disclosure.

FIG. 6 is a schematic flow chart of another control method consistent with embodiments of the disclosure.

FIG. 7 is a schematic flow chart of another control method consistent with embodiments of the disclosure.

FIG. 8 is a schematic flow chart of another control method consistent with embodiments of the disclosure.

FIG. 9 is a schematic flow chart of another control method consistent with embodiments of the disclosure.

FIG. 10 is a schematic flow chart of another control method consistent with embodiments of the disclosure.

FIG. 11 is a schematic flow chart of another control method consistent with embodiments of the disclosure.

FIG. 12 is a schematic flow chart of another control method consistent with embodiments of the disclosure.

FIG. 13 is a schematic flow chart of another control method consistent with embodiments of the disclosure.

FIG. 14 is a schematic block diagram of another aircraft control system consistent with embodiments of the disclosure.

FIG. 15 is a schematic block diagram of another aircraft control system consistent with embodiments of the disclosure.

FIG. 16 is a schematic block diagram of another aircraft control system consistent with embodiments of the disclosure.

Description of main components and reference numerals

| | |
|---|---|
| Aircraft control system | 100 |
| Rotorcraft | 10 |
| Rotor motor | 12 |
| Gimbal | 14 |
| Wearable electronic device | 20 |
| Motion state detecting circuit | 22 |
| Processor | 30 |
| Remote controller | 40 |
| Emergency stop button | 50 |

### DETAILED DESCRIPTION OF THE EMBODIMENTS

Technical solutions of the present disclosure will be described in detail. Example embodiments will be described with reference to the accompanying drawings, in which the same numbers refer to the same or similar elements unless otherwise specified. It will be appreciated that the described embodiments are merely examples and not to limit the scope of the disclosure.

The terms “first,” “second,” or the like in the specification, claims, and the drawings of the disclosure are merely illustrative, e.g. distinguishing similar elements, defining technical features, or the like, and are not intended to indicate or imply the importance of the corresponding elements or the number of the technical features. Thus, features defined as “first” and “second” may explicitly or implicitly include one or more of the features. As used herein, “multiple” means two or more, unless there are other clear and specific limitations.

As used herein, the terms “mounted,” “coupled,” and “connected” should be interpreted broadly, unless there are other clear and specific limitations. For example, the connection between two assemblies may be a fixed connection, a detachable connection, or an integral connection. The connection may also be a mechanical connection, an electrical connection, or a mutual communication connection. Furthermore, the connection may be a direct connection or an indirect connection via an intermedium, an internal connection between the two assemblies or an interaction between the two assemblies.

Various example embodiments corresponding to different implementations of the disclosure will be described. For simplification purposes, the elements and configurations for the specific embodiments are described below. It will be appreciated that the described embodiments are examples only and not intended to limit the scope of the disclosure. Moreover, the references of numbers or letters in various example embodiments are merely for the purposes of clear and simplification, and do not indicate the relationship between the various example embodiments and/or configurations. In addition, the use of other processes and/or materials will be apparent to those skilled in the art from consideration of the examples of various specific processes and materials disclosed herein.

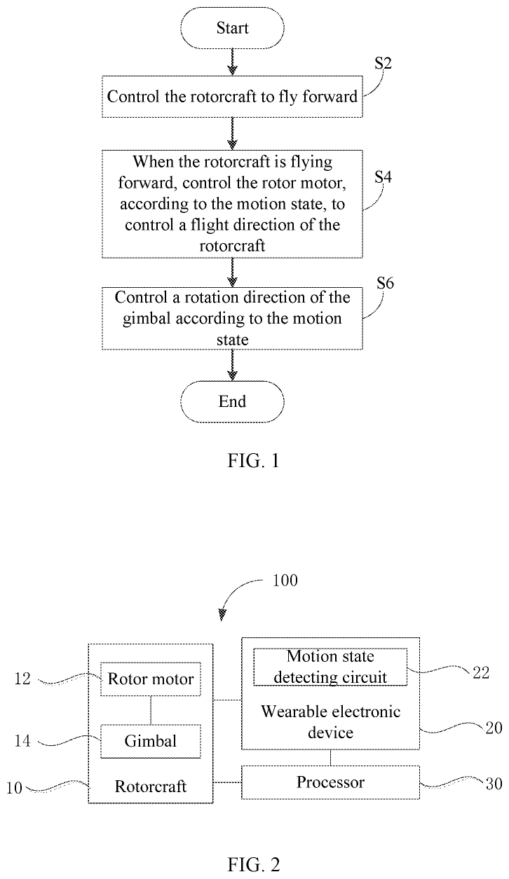

FIG. 1 is a schematic flow chart of an example control method consistent with the disclosure. FIG. 2 is a schematic block diagram of an example aircraft control system 100 consistent with the disclosure. The control method shown in FIG. 1 can be used to control a rotorcraft 10 of the aircraft control system 100 shown in FIG. 2. As shown in FIG. 2, the aircraft control system 100 includes the rotorcraft 10, a wearable electronic device 20, and a processor 30. The rotorcraft 10 includes a rotor motor 12 and a gimbal 14. The rotorcraft 10 is configured to communicate with the wearable electronic device 20. The wearable electronic device 20 includes a motion state detecting circuit 22 (motion detector) configured to acquire a motion state of a body part of the user.

As shown in FIG. 1, at S2, the rotorcraft 10 is controlled to fly forward.

At S4, when the rotorcraft 10 is flying forward, the rotor motor 12 is controlled according to the motion state, to control a flight direction of the rotorcraft 10.

At S6, a rotation direction of the gimbal 14 is controlled according to the motion state.

In some embodiments, one or both of the processes at S4 and S6 can be implemented.

As shown in FIG. 2, the processor 30 is coupled to the rotorcraft 10 and can be configured to control the rotorcraft 10 to fly forward. When the rotorcraft 10 is flying forward, the processor 30 can control the rotor motor 12 according to the motion state, to control the flight direction of the rotorcraft 10, and/or control the rotation direction of the gimbal 14 according to the motion state.

That is, the control method can be implemented by the aircraft control system 100, and the processes at S2, S4, and S6 can be implemented by the processor 30.

In some embodiments, the processor 30 can be arranged at the rotorcraft 10, i.e., the rotorcraft 10 can include the processor 30, and the processor 30 can be configured to directly control the rotorcraft 10. For example, the wearable electronic device 20 can transmit the motion state of the body part of the user to the rotorcraft 10. After the rotorcraft 10 receives the motion state of the body part of the user, the processor 30 of the rotorcraft 10 can process the motion state of the body part of the user to generate a control signal to control the rotor motor 12 and the gimbal 14. In some embodiments, the processor 30 may include a flight control circuit (flight controller) of rotorcraft 10.

In some embodiments, the processor 30 can be arranged at the wearable electronic device 20, i.e., the wearable electronic device 20 can include the processor 30, and the processor 30 can be configured to indirectly control the rotorcraft 10. For example, the processor 30 can obtain the motion state of the body part of the user through the motion state detecting circuit 22, and generate the control signal according to the motion state, and transmit the control signal to the rotorcraft 10. The rotorcraft 10 can control the rotor motor 12 and the gimbal 14, according to the control signal sent by the processor 30. In some embodiments, the flight control circuit (flight controller) of the rotorcraft 10 can receive the control signal, and control the rotor motor 12 and the gimbal 14 according to the control signal.

The control method, the aircraft control system 100, and the rotorcraft 10 can utilize the wearable electronic device 20 to control the rotorcraft 10. As such, the operation can be simple and the user's hands can be freed.

In some embodiments, the motion state detecting circuit 22 can include an inertia detecting circuit. The inertia detecting circuit can include a sensor, such as an acceleration sensor, an angular velocity sensor, an angular acceleration sensor, or the like, that can sense and determine the motion state of the body part of the user, which is not limited herein.

It can be appreciated that the rotorcraft 10 can refer to an aircraft that uses a lift force generated by a rotor motor to balance the gravity of the aircraft and control a stability and attitude of the aircraft by a rotation speed of the rotor motor of the aircraft. In some embodiments, the rotorcraft 10 can include an unmanned rotorcraft.

In some embodiments, when the rotorcraft 10 is controlled by the wearable electronic device 20, the rotorcraft 10 can be first controlled to fly forward. For example, the rotorcraft 10 can fly forward at a predetermined speed and use a forward direction as an initial direction, such that the flight control of the rotorcraft 10 can be achieved by controlling the flight direction of the rotorcraft 10. The control method can be simple and easy to perform, and can be convenient for the user to move his body part.

In some embodiments, the predetermined speed can be any value within a forward flight speed range that the rotorcraft 10 can achieve, and can be set by the user or preset in the rotorcraft 10 or the wearable electronic device 20, which is not limited herein.

It can be appreciated that the control method can be used to control the flight direction of the rotorcraft 10 alone, control the rotation direction of the gimbal 14 alone, or simultaneously control the flight direction of the rotorcraft 10 and the rotation direction of the gimbal 14, which is not limited herein.

The wearable electronic device 20 can be worn on any body part that is convenient for the user to move, such as a head, a hand, or a foot.

In some embodiments, the wearable electronic device 20 can include a head-mounted display device, and the rotorcraft 10 can be controlled using the head-mounted display device. It can be appreciated that the head-mounted display device can be used to display information captured by a load of the rotorcraft 10, such as images (e.g. still images and/or moving images) captured by a camera. The head-mounted display device can provide a view angle of the rotorcraft 10 to the user, such that the better view angle can be achieved. Therefore, the user can control the rotorcraft 10 using the head-mounted display device, according to a situation in a field of view of the rotorcraft 10, thereby enabling a better control effect.

In some embodiments, the wearable electronic device 20 can be a hand-worn electronic device, a foot-worn electronic device, or an electronic device worn by any body part of the user, which is not limited herein. When the wearable electronic device 20 is the hand-worn electronic device or the foot-worn electronic device, an image captured by the rotorcraft 10 can be displayed on another display device arranged outside the wearable electronic device 20, and the user can obtain the view angle of the rotorcraft 10 by observing the another display device.

In some embodiments, the gimbal 14 can include a three-axis gimbal. The body part of the user, the rotorcraft 10, and the gimbal 14 can have three attitude angles, i.e., a yaw angle, a pitch angle, and a roll angle. A negative yaw angle can correspond to a leftward rotation, and a positive yaw angle can correspond to a rightward rotation. A negative pitch angle can correspond to a downward rotation, and a positive pitch angle can correspond to an upward rotation. A negative roll angle can correspond to a leftward deflection of the gimbal 14 or a leftward roll of the rotorcraft 10, and a positive roll angle can correspond to a rightward deflection of the gimbal 14 or a rightward roll of the rotorcraft 10.

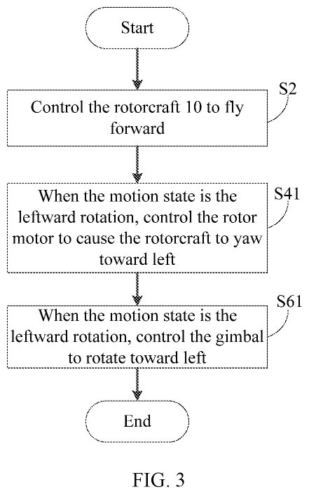

FIG. 3 is a schematic flow chart of another example control method consistent with the disclosure. In some embodiments, the motion state can include the leftward rotation.

As shown in FIG. 3, the process S4 includes, when the motion state is the leftward rotation, controlling the rotor motor 12 to cause the rotorcraft 10 to yaw toward left (S41).

The process S6 includes, when the motion state is the leftward rotation, controlling the gimbal 14 to rotate toward left (S61).

In some embodiments, the motion state includes the leftward rotation. The processor 30 can be configured to, when the motion state is the leftward rotation, control the rotor motor 12 to cause the rotorcraft 10 to yaw toward left, and/or control the gimbal 14 to rotate toward left.

The processes at S41 and S61 can be implemented by the processor 30. As such, the rotorcraft 10 can be controlled to yaw toward left and/or the gimbal 14 can be controlled to rotate toward left.

Taking the head-mounted display device working with the three-axis gimbal as an example, when the user's head is turned to the left, the processor 30 can control the rotation speed of the rotor motor 12 to cause the rotorcraft 10 to fly toward the left. Therefore, the processor 30 can control the rotorcraft 10 to yaw toward the left of the initial direction, and can also control the gimbal 14 to rotate toward left. An extent to which the rotorcraft 10 yaws and the rotation angle of the gimbal 14 can be determined by a leftward rotation angle of the motion state. A yaw speed of the rotorcraft 10 and a rotation speed of the gimbal 14 can be determined by a leftward rotation speed of the motion state.

In some embodiments, the process at S41 can be implemented before the process at S61. In some other embodiments, the process at S41 can be implemented after the process at S61, or the process at S41 and the process at S61 can be implemented simultaneously, which is not limited herein.

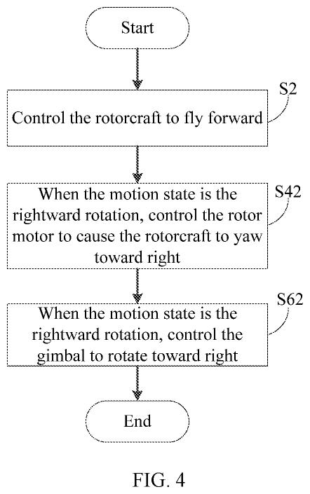

FIG. 4 is a schematic flow chart of another example control method consistent with the disclosure. In some embodiments, the motion state can include the rightward rotation.

As shown in FIG. 4, the process S4 includes, when the motion state is the rightward rotation, controlling the rotor motor 12 to cause the rotorcraft 10 to yaw toward right (S42).

The process S6 includes, when the motion state is the rightward rotation, controlling the gimbal 14 to rotate toward right (S62).

In some embodiments, the motion state includes the rightward rotation. The processor 30 can be configured to, when the motion state is the rightward rotation, control the rotor motor 12 to cause the rotorcraft 10 to yaw toward right, and/or control the gimbal 14 to rotate toward right.

The processes at S42 and S62 can be implemented by the processor 30. As such, the rotorcraft 10 can be controlled to yaw toward right and/or the gimbal 14 can be controlled to rotate toward right.

Taking the head-mounted display device working with the three-axis gimbal as an example, when the user's head is turned to the right, the processor 30 can control the rotation speed of the rotor motor 12 to cause the rotorcraft 10 to fly toward right. Therefore, the processor 30 can control the rotorcraft 10 to yaw toward the right of the initial direction, and can also control the gimbal 14 to rotate toward right. The extent to which the rotorcraft 10 yaws and the rotation angle of the gimbal 14 can be determined by a rightward rotation angle of the motion state. The yaw speed of the rotorcraft 10 and the rotation speed of the gimbal 14 can be determined by a rightward rotation speed of the motion state.

In some embodiments, the process at S42 can be implemented before the process at S62. In some other embodiments, the process at S42 can be implemented after the process at S62, or the process at S42 and the process at S62 can be implemented simultaneously, which is not limited herein.

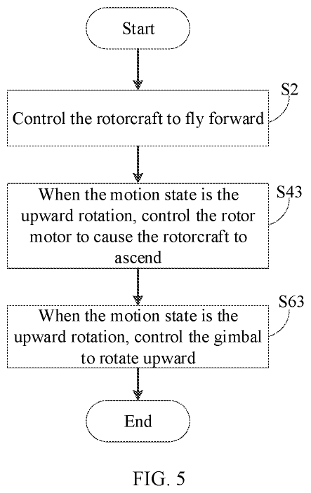

FIG. 5 is a schematic flow chart of another example control method consistent with the disclosure. In some embodiments, the motion state can include an upward rotation.

As shown in FIG. 5, the process S4 includes, when the motion state is the upward rotation, controlling the rotor motor 12 to cause the rotorcraft 10 to ascend (S43).

The process S6 includes, when the motion state is the upward rotation, controlling the gimbal 14 to rotate upward (S63).

In some embodiments, the motion state includes the upward rotation. The processor 30 can be configured, when the motion state is the upward rotation, to control the rotor motor 12 to cause the rotorcraft 10 to ascend, and/or to control the gimbal 14 to rotate upward.

The processes at S43 and S63 can be implemented by the processor 30. As such, the rotorcraft 10 can be controlled to ascend and/or the gimbal 14 can be controlled to rotate upward.

Taking the head-mounted display device working with the three-axis gimbal as an example, when the user's head is turned upward, the processor 30 can control the rotation speed of the rotor motor 12 to cause the rotorcraft 10 to ascend. Therefore, the processor 30 can control the rotorcraft 10 to fly above the initial direction, and can also control the gimbal 14 to rotate upward. An extent to which the rotorcraft 10 ascends and the rotation angle of the gimbal 14 can be determined by an upward rotation angle of the motion state. An ascending speed of the rotorcraft 10 and the rotation speed of the gimbal 14 can be determined by an upward rotation speed of the motion state.

In some embodiments, the process at S43 can be implemented before the process at S63. In some other embodiments, the process at S43 can be implemented after the process at S63, or the process at S43 and the process at S63 can be implemented simultaneously, which is not limited herein.

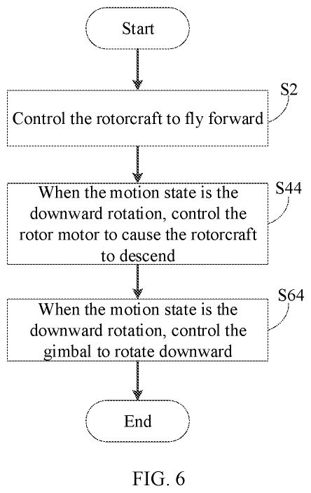

FIG. 6 is a schematic flow chart of another example control method consistent with the disclosure. In some embodiments, the motion state can include a downward rotation.

As shown in FIG. 6, the process S4 includes, when the motion state is the downward rotation, controlling the rotor motor 12 to cause the rotorcraft 10 to descend (S44).

The process S6 includes, when the motion state is the downward rotation, controlling the gimbal 14 to rotate downward (S64).

In some embodiments, the motion state includes the downward rotation. The processor 30 can be configured to, when the motion state is the downward rotation, control the rotor motor 12 to cause the rotorcraft 10 to descend, and/or control the gimbal 14 to rotate downward.

The processes at S44 and S64 can be implemented by the processor 30. As such, the rotorcraft 10 can be controlled to descend and/or the gimbal 14 can be controlled to rotate downward.

Taking the head-mounted display device working with the three-axis gimbal as an example, when the user's head is turned downward, the processor 30 can control the rotation speed of the rotor motor 12 to cause the rotorcraft 10 to descend. Therefore, the processor 30 can control the rotorcraft 10 to fly below the initial direction, and can also control the gimbal 14 to rotate downward. An extent to which the rotorcraft 10 descends and the rotation angle of the gimbal 14 can be determined by a downward rotation angle of the motion state. A descending speed of the rotorcraft 10 and the rotation speed of the gimbal 14 can be determined by a downward rotation speed of the motion state.

In some embodiments, the process at S44 can be implemented before the process at S64. In some other embodiments, the process at S44 can be implemented after the process at S64, or the process at S44 and the process at S64 can be implemented simultaneously, which is not limited herein.

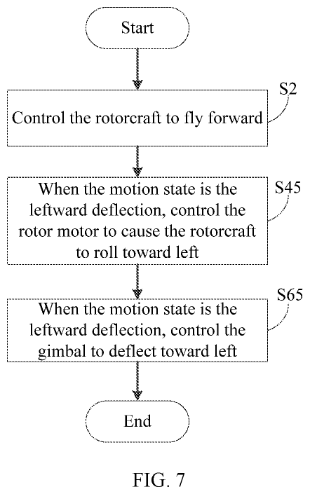

FIG. 7 is a schematic flow chart of another example control method consistent with the disclosure. In some embodiments, the motion state can include a leftward deflection.

As shown in FIG. 7, the process S4 includes, when the motion state is the leftward deflection, controlling the rotor motor 12 to cause the rotorcraft 10 to roll toward left (S45). The process S6 includes, when the motion state is the leftward deflection, controlling the gimbal 14 to deflect toward left (S65).

In some embodiments, the motion state includes the leftward deflection. The processor 30 can be configured to, when the motion state is the leftward deflection, control the rotor motor 12 to cause the rotorcraft 10 to roll toward left, and/or control the gimbal 14 to deflect toward left.

The processes at S45 and S65 can be implemented by the processor 30. As such, the rotorcraft 10 can be controlled to roll toward left and/or the gimbal 14 can be controlled to deflect toward left.

Taking the head-mounted display device working with the three-axis gimbal as an example, when the user's head is deflected leftward, the processor 30 can control the rotation speed of the rotor motor 12 to cause the rotorcraft 10 to roll toward left. Therefore, the processor 30 can control the rotorcraft 10 to change its attitude relative to the ground, e.g., a left side of the rotorcraft 10 facing the ground (facing downward) and a right side of the rotorcraft 10 facing the sky (facing upward), and can also control the gimbal 14 to deflect toward left. An extent to which the rotorcraft 10 rolls and a deflection angle of the gimbal 14 can be determined by a leftward deflection angle of the motion state. A roll speed of the rotorcraft 10 and a deflection speed of the gimbal 14 can be determined by a leftward deflection speed of the motion state.

In some embodiments, the process at S45 can be implemented before the process at S65. In some other embodiments, the process at S45 can be implemented after the process at S65, or the process at S45 and the process at S65 can be implemented simultaneously, which is not limited herein.

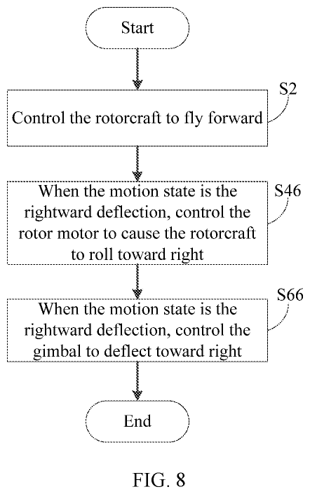

FIG. 8 is a schematic flow chart of another example control method consistent with the disclosure. In some embodiments, the motion state can include a rightward deflection.

As shown in FIG. 8, the process S4 includes, when the motion state is the rightward deflection, controlling the rotor motor 12 to cause the rotorcraft 10 to roll toward right (S46). The process S6 includes, when the motion state is the rightward deflection, controlling the gimbal 14 to deflect toward right (S66).

In some embodiments, the motion state includes the rightward deflection. The processor 30 can be configured to, when the motion state is the rightward deflection, control the rotor motor 12 to cause the rotorcraft 10 to roll toward right, and/or control the gimbal 14 to deflect toward right.

The processes at S46 and S66 can be implemented by the processor 30. As such, the rotorcraft 10 can be controlled to roll toward right and/or the gimbal 14 can be controlled to deflect toward right.

Taking the head-mounted display device working with the three-axis gimbal as an example, when the user's head is deflected rightward, the processor 30 can control the rotation speed of the rotor motor 12 to cause the rotorcraft 10 to roll toward right. Therefore, the processor 30 can control the rotorcraft 10 to change its attitude relative to the ground, e.g., the right side of the rotorcraft 10 facing the ground and the left side of the rotorcraft 10 facing the sky, and can also control the gimbal 14 to deflect toward right. The extent to which the rotorcraft 10 rolls and the deflection angle of the gimbal 14 can be determined by a rightward deflection angle of the motion state. The roll speed of the rotorcraft 10 and the deflection speed of the gimbal 14 can be determined by a rightward deflection speed of the motion state.

In some embodiments, the process at S46 can be implemented before the process at S66. In some other embodiments, the process at S46 can be implemented after the process at S66, or the process at S46 and the process at S66 can be implemented simultaneously, which is not limited herein.

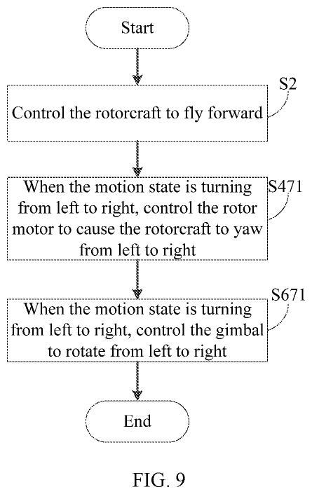

FIG. 9 is a schematic flow chart of another example control method consistent with the disclosure. In some embodiments, the motion state can include turning from left to right.

As shown in FIG. 9, the process S4 includes, when the motion state is turning from left to right, controlling the rotor motor 12 to cause the rotorcraft 10 to yaw from left to right (S471). The process S6 includes, when the motion state is turning from left to right, controlling the gimbal 14 to rotate from left to right (S671).

In some embodiments, the motion state includes turning from left to right. The processor 30 can be configured to, when the motion state is turning from left to right, control the rotor motor 12 to cause the rotorcraft 10 to yaw from left to right, and/or control the gimbal 14 to rotate from left to right.

The processes at S471 and S671 can be implemented by the processor 30. As such, the rotorcraft 10 can be controlled to yaw from left to right, and/or the gimbal 14 can be controlled to rotate from left to right.

Taking the head-mounted display device working with the three-axis gimbal as an example, when the user's head is turning from left to right, the processor 30 can control the rotation speed of the rotor motor 12 to cause the rotorcraft 10 to fly from left to right. Therefore, the processor 30 can control the rotorcraft 10 to yaw from the left of the initial direction to a right of the initial direction, and can also control the gimbal 14 to rotate from left to right. The extent to which the rotorcraft 10 yaws and the rotation angle of the gimbal 14 can be determined by an angle of the motion state when turning from left to right. The yaw speed of the rotorcraft 10 and the rotation speed of the gimbal 14 can be determined by a speed of the motion state when turning from left to right.

In some embodiments, the process at S471 can be implemented before the process at S671. In some other embodiments, the process at S471 can be implemented after the process at S671, or the process at S471 and the process at S671 can be implemented simultaneously, which is not limited herein.

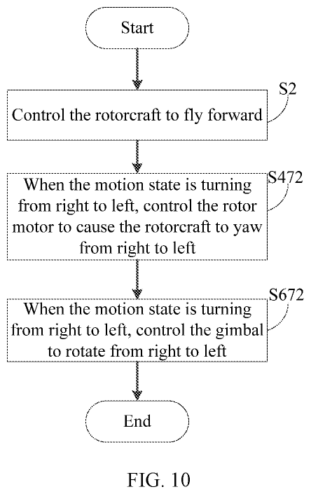

FIG. 10 is a schematic flow chart of another example control method consistent with the disclosure. In some embodiments, the motion state can include turning from right to left.

As shown in FIG. 10, the process S4 includes, when the motion state is turning from right to left, controlling the rotor motor 12 to cause the rotorcraft 10 to yaw from right to left (S472). The process S6 includes, when the motion state is turning from right to left, controlling the gimbal 14 to rotate from right to left (S672).

In some embodiments, the motion state includes turning from right to left. The processor 30 can be configured to, when the motion state is turning from right to left, control the rotor motor 12 to cause the rotorcraft 10 to yaw from right to left, and/or control the gimbal 14 to rotate from right to left.

The processes at S472 and S672 can be implemented by the processor 30. As such, the rotorcraft 10 can be controlled to yaw from right to left, and/or the gimbal 14 can be controlled to rotate from right to left.

Taking the head-mounted display device working with the three-axis gimbal as an example, when the user's head is turning from right to left, the processor 30 can control the rotation speed of the rotor motor 12 to cause the rotorcraft 10 to fly from right to left. Therefore, the processor 30 can control the rotorcraft 10 to yaw from the right of the initial direction to the left of the initial direction, and can also control the gimbal 14 to rotate from right to left. The extent to which the rotorcraft 10 yaws and the rotation angle of the gimbal 14 can be determined by an angle of the motion state when turning from right to left. The yaw speed of the rotorcraft 10 and the rotation speed of the gimbal 14 can be determined by a speed of the motion state when turning from right to left.

In some embodiments, the process at S472 can be implemented before the process at S672. In some other embodiments, the process at S472 can be implemented after the process at S672, or the process at S472 and the process at S672 can be implemented simultaneously, which is not limited herein.

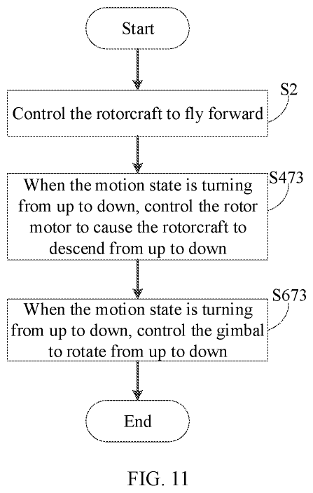

FIG. 11 is a schematic flow chart of another example control method consistent with the disclosure. In some embodiments, the motion state can include turning from up to down.

As shown in FIG. 11, the process S4 includes, when the motion state is turning from up to down, controlling the rotor motor 12 to cause the rotorcraft 10 to descend from up to down (S473). The process S6 includes, when the motion state is turning from up to down, controlling the gimbal 14 to rotate from up to down (S673).

In some embodiments, the motion state includes turning from up to down. The processor 30 can be configured to, when the motion state is turning from up to down, control the rotor motor 12 to cause the rotorcraft 10 to descend from up to down, and/or to control the gimbal 14 to rotate from up to down.

The processes at S473 and S673 can be implemented by the processor 30. As such, the rotorcraft 10 can be controlled to descend from up to down, and/or the gimbal 14 can be controlled to rotate from up to down.

Taking the head-mounted display device working with the three-axis gimbal as an example, when the user's head is turning from up to down, the processor 30 can control the rotation speed of the rotor motor 12 to cause the rotorcraft 10 to fly from up to down. Therefore, the processor 30 can control the rotorcraft 10 to descend from above the initial direction to below the initial direction, and can also control the gimbal 14 to rotate from up to down. An extent to which the rotorcraft 10 descends and the rotation angle of the gimbal 14 can be determined by an angle of the motion state when turning from up to down. A diving speed of the rotorcraft 10 and the rotation speed of the gimbal 14 can be determined by a speed of the motion state when turning from up to down.

In some embodiments, the process at S473 can be implemented before the process at S673. In some other embodiments, the process at S473 can be implemented after the process at S673, or the process at S473 and the process at S673 can be implemented simultaneously, which is not limited herein.

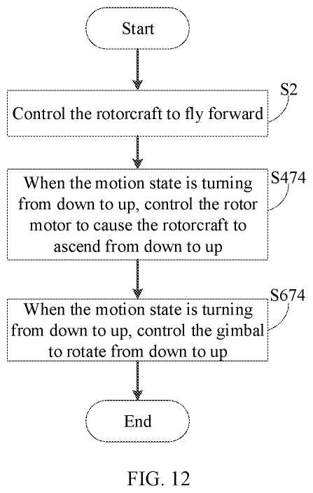

FIG. 12 is a schematic flow chart of another example control method consistent with the disclosure. In some embodiments, the motion state can include turning from down to up.

As shown in FIG. 12, the process S4 includes, when the motion state is turning from down to up, controlling the rotor motor 12 is controlled to cause the rotorcraft 10 to ascend from down to up (S474). The process S6 includes, when the motion state is turning from down to up, controlling the gimbal 14 to rotate from down to up (S674).

In some embodiments, the motion state includes turning from down to up. The processor 30 can be configured to, when the motion state is turning from down to up, control the rotor motor 12 to cause the rotorcraft 10 to ascend from down to up, and/or control the gimbal 14 to rotate from down to up.

The processes at S474 and S674 can be implemented by the processor 30. As such, the rotorcraft 10 can be controlled to ascend from down to up, and/or the gimbal 14 can be controlled to rotate from down to up.

Taking the head-mounted display device working with the three-axis gimbal as an example, when the user's head is turning from down to up, the processor 30 can control the rotation speed of the rotor motor 12 to cause the rotorcraft 10 to fly from down to up. Therefore, the processor 30 can control the rotorcraft 10 to ascend from below the initial direction to above the initial direction, and can also control the gimbal 14 to rotate from down to up. An extent to which the rotorcraft 10 ascends and the rotation angle of the gimbal 14 can be determined by an angle of the motion state when turning from down to up. A ascending speed of the rotorcraft 10 and the rotation speed of the gimbal 14 can be determined by a speed of the motion state when turning from down to up.

In some embodiments, the process at S474 can be implemented before the process at S674. In some other embodiments, the process at S474 can be implemented after the process at S674, or the process at S474 and the process at S674 can be implemented simultaneously, which is not limited herein.

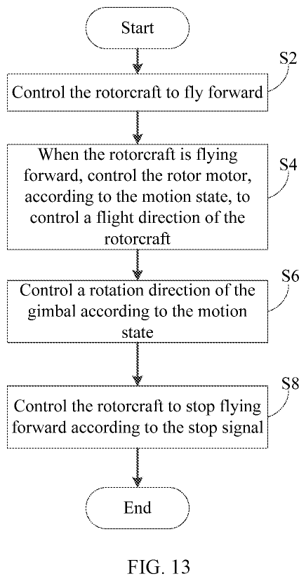

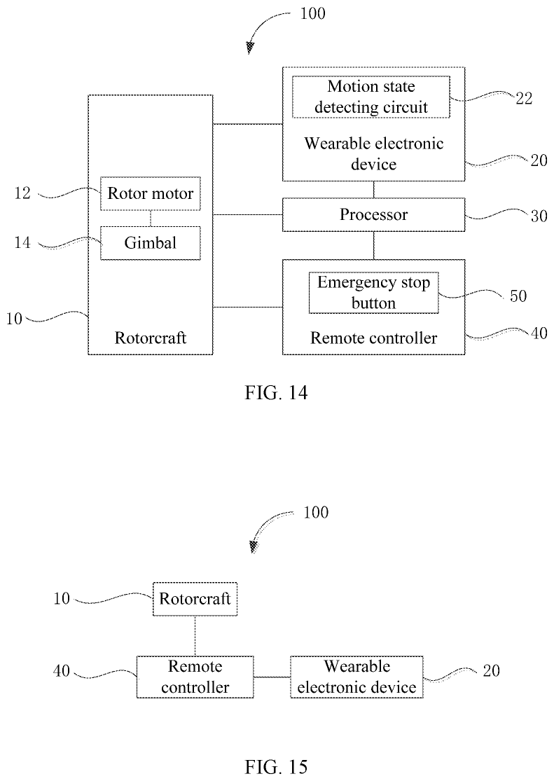

FIG. 13 is a schematic flow chart of another example control method consistent with the disclosure. FIG. 14 is a schematic block diagram of another example of the aircraft control system 100 consistent with the disclosure. The control method shown in FIG. 13 can be used to control the rotorcraft 10 of the aircraft control system 100 shown in FIG. 14. As shown in FIG. 14, the aircraft control system 100 further includes a remote controller 40. The rotorcraft 10 can communicate with the remote controller 40, and the remote controller 40 can be configured to control the flight of the rotorcraft 10. In some embodiments, as shown in FIG. 14, the remote controller 40 includes an emergency stop button 50. In some embodiments, the emergency stop button 50 can be arranged at the wearable electronic device 20. In some other embodiments, both the wearable electronic device 20 and the remote controller 40 can include the emergency stop button 50. The emergency stop button 50 can be configured to generate a stop signal when being pressed.

As shown in FIG. 13, at S8, the rotorcraft 10 is controlled to stop flying forward according to the stop signal.

The processor 30 can be configured to control the rotorcraft 10 to stop flying forward according to the stop signal. The process at S8 can be implemented by the processor 30. As such, the emergency stop button 50 can be used to control the rotorcraft 10 to stop flying forward when an accident is happening or about to happen, thereby ensuring the safety of the rotorcraft 10.

For example, the emergency stop button 50 can be arranged at the remote controller 40, or at the wearable electronic device 20, or both the wearable electronic device 20 and the remote controller 40 can each include an emergency stop button.

When an emergency or accident happened or is about to happen, the user can quickly press the emergency stop button 50 to cause the rotorcraft 10 to stop flying forward. Stopping the rotorcraft 10 from flying forward can include the rotorcraft 10 hovering in the air or landing to a predetermined position. The user can choose a stopping manner of the rotorcraft 10 according to actual requirements.

In some embodiments, the stop signal can also be generated by, for example, an obstacle sensor, or the like, on the rotorcraft 10. For example, when the rotorcraft 10 encounters an obstacle, the obstacle sensor can generate the stop signal and control the rotorcraft 10 to stop flying forward or change a flight path according to the control signal.

In some embodiments, the aircraft control system 100 can include the wearable electronic device 20 configured to directly control the rotorcraft 10. As such, the rotorcraft 10 can be directly controlled using motion information of the wearable electronic device 20 (e.g., the motion state of the body part of the user).

In some embodiments, the aircraft control system 100 can include the wearable electronic device 20 and the remote controller 40, both of which are capable of directly controlling the rotorcraft 10. As such, the rotorcraft 10 can be simultaneously controlled by the wearable electronic device 20 and the remote controller 40, thereby enriching the control method of the rotorcraft 10.

FIG. 15 is a schematic block diagram of another example of the aircraft control system 100 consistent with the disclosure. As shown in FIG. 15, in some embodiments, the aircraft control system 100 includes the wearable electronic device 20 and the remote controller 40, and the wearable electronic device 20 communicates with the rotorcraft 10 via the remote controller 40. As such, the remote controller 40 can directly control the rotorcraft 10, and the wearable electronic device 20 can indirectly control the rotorcraft 10, such that the rotorcraft 10 can establish a channel for communication with a single device, thereby reducing an energy consumption and simplifying a control process. The remote controller 40 can serve as a relay device for the motion information of the wearable electronic device 20, thereby saving any improvement on the existing wearable electronic device 20 and reducing the cost. For example, the remote controller 40 can communicate with the rotorcraft 10 at a greater distance, and the remote controller 40 can communicate with the wearable electronic device 20 at a relatively close distance.

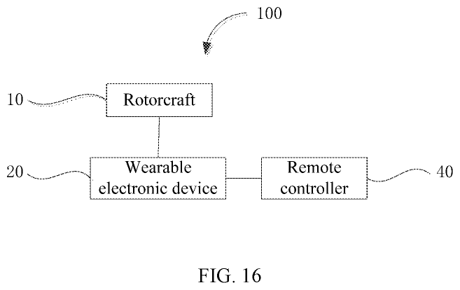

FIG. 16 is a schematic block diagram of another example of the aircraft control system 100 consistent with the disclosure. As shown in FIG. 16, in some embodiments, the aircraft control system 100 includes the wearable electronic device 20 and the remote controller 40, and the remote controller 40 communicates with the rotorcraft 10 via the wearable electronic device 20. As such, the wearable electronic device 20 can directly control the rotorcraft 10, and the remote controller 40 can indirectly control the rotorcraft 10, such that the rotorcraft 10 can establish the channel for communication with a single device, thereby reducing the energy consumption and simplifying the control process.

It can be appreciated that the aircraft control system 100 can include any number of remote controllers 40 and at least one wearable electronic device 20, which are not limited herein.

The terms “one embodiment,” “some embodiments,” “an example embodiment,” “for example,” “as a specific example,” “some examples,” or the like in the specification of the disclosure mean that the specific features, structures, materials, or characteristics described with reference to the embodiments or examples are included in at least one of the embodiments or examples of the disclosure. The use of the above terms in the specification of the disclosure may not refer to the same embodiment or example of the disclosure. In addition, the specific features, structures, materials, or characteristics described may be combined in any suitable manner in any one or more of embodiments or examples of the disclosure.

It is appreciated that any process or method described in the flowcharts or in other manners may be a module, section, or portion of program codes includes one or more of executable instructions for implementing a specific logical function or process. The disclosed methods may be implemented in other manners not described here. For example, the functions may not be performed in the order shown or discussed in the specification of the disclosure. That is, the functions may be performed basically in the same way or the reverse order according to the functions involved.

The logics and/or processes described in the flowcharts or in other manners may be, for example, an order list of the executable instructions for implementing logical functions, which may be implemented in any computer-readable storage medium and used by an instruction execution system, apparatus, or device, such as a computer-based system, a system including a processor, or another system that can fetch and execute instructions from an instruction execution system, apparatus, or device, or used in a combination of the instruction execution system, apparatus, or device. The computer-readable storage medium may be any apparatus that can contain, store, communicate, propagate, or transmit the program for using by or in a combination of the instruction execution system, apparatus, or device. The computer readable medium may include, for example, an electrical assembly having one or more wires, e.g., electronic apparatus, a portable computer disk cartridge. e.g., magnetic disk, a random access memory (RAM), a read only memory (ROM), an erasable programmable read only memory (EPROM or flash memory), an optical fiber device, or a compact disc read only memory (CDROM). In addition, the computer readable medium may be a paper or another suitable medium upon which the program can be printed. The program may be obtained electronically, for example, by optically scanning the paper or another medium, and editing, interpreting, or others processes, and then stored in a computer memory.

Those of ordinary skill in the art will appreciate that the example elements and steps described above can be implemented in electronic hardware, computer software, firmware, or a combination thereof. Multiple processes or methods may be implemented in a software or firmware stored in the memory and executed by a suitable instruction execution system. When being implemented in electronic hardware, the example elements and processes described above may be implemented using any one or a combination of: discrete logic circuits having logic gate circuits for implementing logic functions on data signals, specific integrated circuits having suitable combinational logic gate circuits, programmable gate arrays (PGA), field programmable gate arrays (FPGAs), and the like.

Those of ordinary skill in the art will appreciate that the entire or part of a method described above may be implemented by relevant hardware instructed by a program. The program may be stored in a computer-readable storage medium. When being executed, the program includes one of the processes of the method or a combination thereof.

In addition, the functional units in the various embodiments of the present disclosure may be integrated in one processing unit, or each unit may be an individual physically unit, or two or more units may be integrated in one unit. The integrated unit described above may be implemented in electronic hardware or computer software. The integrated unit may be stored in a computer readable medium, which can be sold or used as a standalone product. The storage medium described above may be a read only memory, a magnetic disk, an optical disk, or the like.

Other embodiments of the disclosure will be apparent to those skilled in the art from consideration of the specification and practice of the embodiments disclosed herein. It is intended that the specification and examples be considered as illustrative only and not to limit the scope of the disclosure, with a true scope and spirit of the invention being indicated by the following claims.

What is claimed is:

1. A control method comprising:
controlling a rotorcraft to fly forward; and
in response to receiving signal indicating a motion state of a body part of a user obtained and communicated by a wearable electronic device, performing a control operation according to the motion state, the control operation including at least one of:
controlling a rotor motor of the rotorcraft to control a flight direction of the rotorcraft; or
controlling a rotation direction of a gimbal of the rotorcraft.

2. The method of claim 1, wherein the wearable electronic device includes a head-mounted display device.

3. The method of claim 1, wherein:
the motion state includes a leftward rotation, and performing the control operation includes at least one of controlling the rotor motor to cause the rotorcraft to yaw toward left or controlling the gimbal to rotate toward left; or
the motion state includes a rightward rotation, and performing the control operation includes at least one of controlling the rotor motor to cause the rotorcraft to yaw toward right or controlling the gimbal to rotate toward right.

4. The method of claim 1, wherein:
the motion state includes an upward rotation, and performing the control operation includes at least one of controlling the rotor motor to cause the rotorcraft to ascend or controlling the gimbal to rotate upward; or
the motion state includes a downward rotation, and performing the control operation includes at least one of controlling the rotor motor to cause the rotorcraft to descend or controlling the gimbal to rotate downward.

5. The method of claim 1, wherein:
the motion state includes a leftward deflection, and performing the control operation includes at least one of controlling the rotor motor to cause the rotorcraft to roll toward left or controlling the gimbal to deflect toward left; or
the motion state includes a rightward deflection, and performing the control operation includes at least one of controlling the rotor motor to cause the rotorcraft to roll toward right or controlling the gimbal to deflect toward right.

6. The method of claim 1, wherein:
the motion state includes turning from left to right, and performing the control operation includes at least one of controlling the rotor motor to cause the rotorcraft to yaw from left to right or controlling the gimbal to rotate from left to right; or
the motion state includes turning from right to left, and performing the control operation includes at least one of controlling the rotor motor to cause the rotorcraft to yaw from right to left or controlling the gimbal to rotate from right to left.

7. The method of claim 1, wherein:
the motion state includes turning from up to down, and performing the control operation includes at least one of controlling the rotor motor to cause the rotorcraft to descend from up to down or controlling the gimbal to rotate from up to down; or
the motion state includes turning from down to up, and performing the control operation includes at least one of controlling the rotor motor to cause the rotorcraft to ascend from down to up or controlling the gimbal to rotate from down to up.

8. The method of claim 1, further comprising:
controlling the rotorcraft to stop flying forward according to a stop signal generated by at least one of an emergency stop button of the wearable electronic device or an emergency stop button of a remote controller communicating with the rotorcraft.

9. The method of claim 1, wherein the wearable electronic device communicates with the rotorcraft via a remote controller configured to control flight of the rotorcraft.

10. The method of claim 1, wherein a remote controller configured to control flight of the rotorcraft communicates with the rotorcraft via the wearable electronic device.

11. An aircraft control system comprising:
a rotorcraft including:
a rotor motor; and
a gimbal;
a wearable electronic device communicating with the rotorcraft and including a motion detector configured to acquire a motion state of a body part of a user; and
a processor configured to:
control the rotorcraft to fly forward; and
in response to receiving a signal sent by the wearable electronic device indicating the motion state, perform a control operation according to the motion state, the control operation including at least one of:
controlling a rotor motor of the rotorcraft to control a flight direction of the rotorcraft; or
controlling a rotation direction of a gimbal of the rotorcraft.

12. The system of claim 11, wherein the wearable electronic device includes a head-mounted display device.

13. The system of claim 11, wherein:
the motion state includes a leftward rotation, and the control operation includes at least one of controlling the rotor motor to cause the rotorcraft to yaw toward left or controlling the gimbal to rotate toward left; or
the motion state includes a rightward rotation, and the control operation includes at least one of controlling the rotor motor to cause the rotorcraft to yaw toward right or controlling the gimbal to rotate toward right.

14. The system of claim 11, wherein:
the motion state includes an upward rotation, and the control operation includes at least one of controlling the rotor motor to cause the rotorcraft to ascend or controlling the gimbal to rotate upward; or
the motion state includes a downward rotation, and the control operation includes at least one of controlling the rotor motor to cause the rotorcraft to descend or controlling the gimbal to rotate downward.

15. The system of claim 11, wherein:
the motion state includes a leftward deflection, and the control operation includes at least one of controlling the rotor motor to cause the rotorcraft to roll toward left or controlling the gimbal to deflect toward left; or
the motion state includes a rightward deflection, and the control operation includes at least one of controlling the rotor motor to cause the rotorcraft to roll toward right or controlling the gimbal to deflect toward right.

16. The system of claim 11, wherein:
the motion state includes turning from left to right, and the control operation includes at least one of controlling the rotor motor to cause the rotorcraft to yaw from left to right or controlling the gimbal to rotate from left to right; or
the motion state includes turning from right to left, and the control operation includes at least one of controlling the rotor motor to cause the rotorcraft to yaw from right to left or controlling the gimbal to rotate from right to left.

17. The system of claim 11, wherein:
the motion state includes turning from up to down, and the control operation includes at least one of controlling the rotor motor to cause the rotorcraft to descend from up to down or controlling the gimbal to rotate from up to down; or
the motion state includes turning from down to up, and the control operation includes at least one of controlling the rotor motor to cause the rotorcraft to ascend from down to up or controlling the gimbal to rotate from down to up.

18. The system of claim 11, wherein:
the rotorcraft communicates with a remote controller;
at least one of the remote controller or the wearable electronic device includes an emergency stop button configured to generate a stop signal; and
the processor is further configured to control the rotorcraft to stop flying forward according to the stop signal.

19. The system of claim 11, wherein the wearable electronic device communicates with the rotorcraft via a remote controller configured to control flight of the rotorcraft.

20. The system of claim 11, wherein a remote controller configured to control flight of the rotorcraft communicates with the rotorcraft via the wearable electronic device.
